(19) United States
(12) Patent Application Publication
(10) Pub. No.: US 2012/0118140 A1
(43) Pub. Date: May 17, 2012

(54) JOIN CONNECTION FOR A PISTON GUIDING UNIT IN A HOUSING

(75) Inventor: Andreas RINNERT, HERZOGENAURACH (DE)

(73) Assignee: SCHAEFFLER TECHNOLOGIES GMBH & CO. KG, Herzogenaurach (DE)

(21) Appl. No.: 13/238,062

(22) Filed: Sep. 21, 2011

(30) Foreign Application Priority Data
Nov. 17, 2010 (DE) 10 2010 051 615.5

(51) Int. Cl. F16J 10/02

(52) U.S. Cl. 92/165 R

(57) ABSTRACT

Join connection for a piston guiding unit, preferably made from steel, in which a piston, in particular a brake or pump piston, is guided movably. The piston guiding unit is screwed to a housing which is preferably produced from aluminum, and the thread of the screw connection has a thread-forming contour.

### CROSS-REFERENCE TO RELATED APPLICATION

This application claims the priority of DE 10 2010 051 615.5 filed Nov. 17, 2010, which is incorporated by reference herein.

### FIELD OF THE INVENTION

Join connection for a piston guiding unit, preferably made from steel, in which a piston, in particular a brake or pump piston in an internal combustion engine, is guided movably. The piston guiding unit is screwed to a housing, which is preferably produced from aluminum.

### BACKGROUND OF THE INVENTION

A piston guiding unit of this type which is screwed to a housing is known from the MultiAir System of FIAT, published www.fiat.de/cgi-bin/pbrand.dll/Fiat_GERMANY/news “Presse and Öffentlichkeitsarbeit” [Press and public relations], January 2010. A pump piston is mounted in this piston guiding unit. The pump piston is guided movably by means of an actuating part and a spring. The piston guiding unit has a metric external thread and is screwed with the latter into a threaded opening of the housing. The thread in the opening and the external thread being are produced by the removal of material.

As a result of the forces, transverse forces of the actuating part and the pressure forces on account of the hydraulic pressure, settling of the screw connection and as a result of different coefficients of expansion of the screw connection partners in conjunction with the great temperature range during the use in an internal combustion engine, there is the problem that the screw connection is released.

Furthermore, the fastening is complicated in terms of production technology, since the thread has to be cut both on the piston guiding unit and in the housing. Furthermore, the assembly complexity is also difficult as a result of narrow parameters which are to be adhered to.

### OBJECT OF THE INVENTION

It is therefore an object of the invention to improve a join connection of the piston guiding unit in the housing in such a way that the above-described disadvantages are avoided and stable, long-term fastening of the piston guiding unit in the housing is achieved inexpensively and using simple means.

### SUMMARY OF THE INVENTION

The object of the invention is achieved by the fact that the thread of the screw connection is produced as a thread-forming contour. Here, at least one of the threads is formed without the removal of material, as a result of which the thread overlap is increased substantially.

In one refinement of the invention, it is proposed that the thread contour which is formed as a nut in the housing is produced without the removal of material. Here, the piston guiding unit which is formed as a screw is screwed into a bore in the housing, the piston guiding unit serving as a thread forming screw which has additional threads for thread forming and produces the thread in the bore of the housing. Here, the material is strain-hardened locally in the bore, with the result that a high flank overlap and play-free pairing are produced.

In a simple way, the bore can be produced in the housing by drilling or else by casting. At its thread start, in particular, the piston guiding unit has partial flattened portions which facilitate the screwing-in and forming of the material in the bore.

This forming without the removal of material, in particular in the bore in the housing as a nut, achieves a situation where there is a fixed connection of the piston guiding unit in the housing with high operational security. Furthermore, the threaded bore in the aluminum housing and the debuting are therefore dispensed with.

### BRIEF DESCRIPTION OF THE DRAWINGS

For further explanation of the invention, reference is made to the drawings, in which one exemplary embodiment of the invention is shown in simplified form and in which:

FIG. 1 shows a side view of a piston guiding unit with a specially designed thread for forming without the removal of material; and

FIG. 2 shows a view of the piston guiding unit in the direction of the thread.

### DETAILED DESCRIPTION OF THE INVENTION

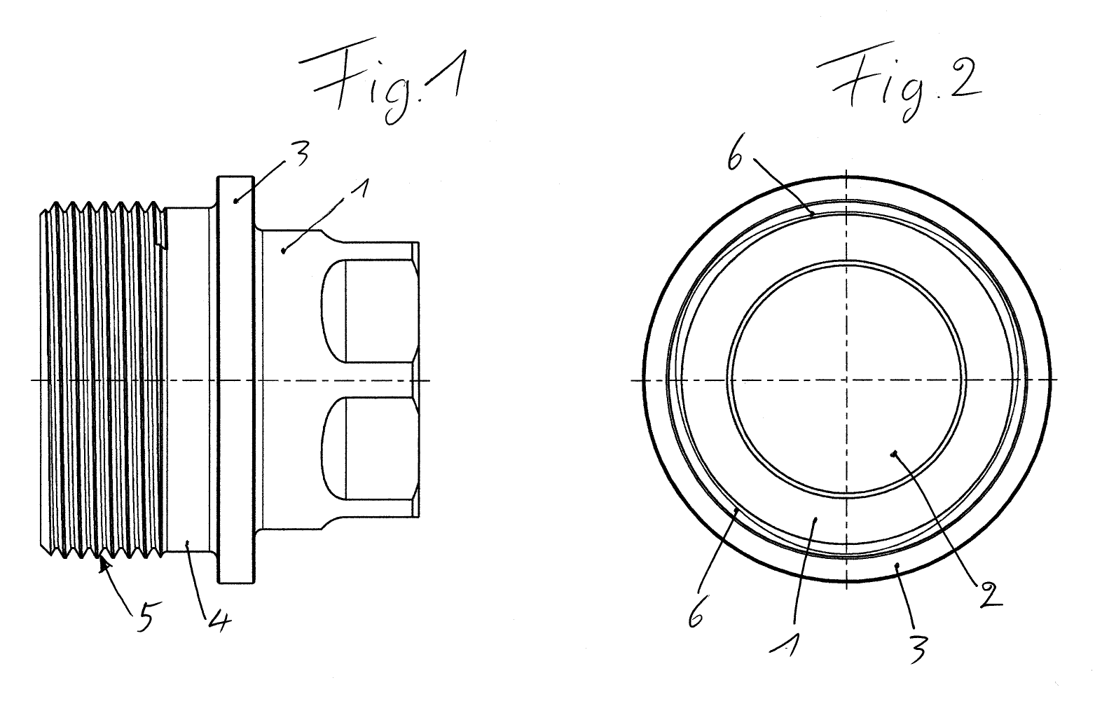

In FIGS. 1 and 2, reference numeral 1 generally denotes a piston guiding unit which has a central bore 2, in which a brake or pump piston (not shown) is guided sealingly which, likewise not shown, is arranged movably in the piston guiding unit by means of an actuating part and a spring.

The piston guiding unit 1 has a collar 3, which is adjoined on one side by a cylindrical fitting surface 4 and a thread which has a thread-forming contour 5 or a corresponding profile. In its starting region, see FIG. 2, the thread has a plurality of flattened portions 6 which facilitate the insertion of the piston guiding unit 1 which is configured as a thread forming screw, and ensure the entry into the forming operation without the removal of material.

### LIST OF REFERENCE NUMERALS

1 Piston Guiding Unit
2 Cylinder Bore
3 Collar
4 Fitting Surface
5 Thread-Forming Contour
6 Flattened Portions

1-5. (canceled)

6. Join connection for a piston guiding unit, preferably made from steel, in which a piston, in particular a brake or pump piston, is guided movably, the piston guiding unit being screwed to a housing which is preferably produced from aluminum, wherein the thread of the screw connection has a thread-forming contour.

7. Join connection according to claim 6, wherein the thread contour which is formed as a nut in the housing is produced without removal of material.

8. Join connection according to claim 6, wherein a bore which is produced by drilling or casting is provided in the housing, into which bore the thread contour is machined without removal of material.

9. Join connection according to claim 6, wherein the piston guiding unit is thread-forming screw.

10. Join connection according to claim 8, wherein the piston guiding unit is screwed into the bore in the housing.
